(19) United States
(12) Patent Application Publication
(10) Pub. No.: US 2010/0129075 A1
(43) Pub. Date: May 27, 2010

(54) TRANSMISSION SYSTEM, TRANSMISSION APPARATUS, AND CONTROL METHOD OF TRANSMISSION SYSTEM

(75) Inventor: Taichi ISHIKAWA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/623,949

(22) Filed: Nov. 23, 2009

(30) Foreign Application Priority Data
Nov. 26, 2008 (JP) 2008-300702

(51) Int. Cl. H04J 14/00

(52) U.S. Cl. 398/45

(57) ABSTRACT

A transmission system includes: a sending apparatus; a receiving apparatus; and an intermediate apparatus, the sending apparatus, the receiving apparatus and the intermediate apparatus being connected in a ring shape via a first transmission line used to transmit a first channel signal and a second channel signal in one direction and a second transmission line used to transmit the first channel signal and the second channel signal in another direction opposite to the one direction, the receiving apparatus including a first phase adjustment unit that adjusts a phase difference between the first channel signal of the first transmission line and the first channel signal of the second transmission line, and the intermediate apparatus including a second phase adjustment unit that adjusts a phase difference between the second channel signal of the first transmission line and the second channel signal of the second transmission line.

### CROSS-REFERENCE TO RELATED APPLICATION

This application is based upon and claims the benefit of priority of the prior Japanese Patent Application No. 2008-300702, filed on Nov. 26, 2008, the entire contents of which are incorporated herein by reference.

### FIELD

A certain aspect of the embodiments discussed herein is related to a transmission system, a transmission apparatus, and a control method of a transmission system.

### BACKGROUND

In recent years, a protection function such as UPSR (Uni-directional path switched ring) and SNCP (Subnetwork Connection Protection) is used in a multiplexing transmission system such as SDH (Synchronous Digital Hierarchy) and SONET (Synchronous Optical Network).

In UPSR/SNCP, when data is transmitted from a sending apparatus to a receiving apparatus by using a ring shaped transmission line of SDH/SONET, a path to one direction (e.g. right-handed direction) and a path to another direction (e.g. left-handed direction) are established in the ring shaped transmission line. The ring shaped transmission line is able to establish multiple paths. Some of the multiple paths are established as the paths to one direction, and others are established as the paths to another direction. For example, if failures occur or maintenances are done in the middle of the paths to the one direction, some of the paths mentioned above are switched to the paths to another direction. This enhances the reliability of the transmission line.

If there is a phase difference between two paths when some of the paths mentioned above are switched from the paths to one direction to the paths to another direction, an instantaneous interruption-free switching of the paths is impossible. Thus, installing a phase adjustment unit that adjusts the phase difference for an instantaneous interruption-free switching of the paths is known, as disclosed in Japanese Laid-open Patent Publication Nos. 08-65282 and No. 2003-348061.

### SUMMARY

According to an aspect of the invention, a transmission system includes: a sending apparatus; a receiving apparatus; and an intermediate apparatus, the sending apparatus, the receiving apparatus and the intermediate apparatus being connected in a ring shape via a first transmission line used to transmit a first channel signal and a second channel signal in one direction and a second transmission line used to transmit the first channel signal and the second channel signal in another direction opposite to the one direction, the receiving apparatus including a first phase adjustment unit that adjusts a phase difference between the first channel signal of the first transmission line and the first channel signal of the second transmission line, and the intermediate apparatus including a second phase adjustment unit that adjusts a phase difference between the second channel signal of the first transmission line and the second channel signal of the second transmission line.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a transmission system in accordance with the first embodiment;

FIG. 2 is a block diagram of a receiving apparatus and an intermediate apparatus;

FIG. 3A is a block diagram of a phase adjustment unit, and FIG. 3B is a time chart of each signal;

FIG. 4 is a diagram illustrating an overview of a phase adjustment with a phase adjustment unit in an intermediate apparatus;

FIG. 5 is a diagram illustrating a path of a second channel at normal times;

FIGS. 6A through 6C are diagrams illustrating a connection of a cross connect unit and a selection unit;

FIG. 7 is a diagram illustrating an overview of when the path at normal times is a route 6;

FIGS. 8A through 8D are diagrams illustrating a connection of a cross connect unit and a selection unit;

FIG. 9 is a diagram illustrating an overview of when a path during maintenance is a route 3;

FIGS. 10A through 10D are diagrams illustrating a connection of a cross connect unit and a selection unit;

FIG. 11 is a diagram illustrating an overview of a system in accordance with the second embodiment;

FIG. 12 is a diagram illustrating an overview of a system in accordance with the third embodiment;

FIG. 13 is a block diagram of a phase adjustment unit in accordance with the third embodiment;

FIG. 14 is a diagram illustrating an overview of a system in accordance with the fourth embodiment; and

FIG. 15 is a block diagram of a phase adjustment unit in accordance with the fourth embodiment.

### DESCRIPTION OF EMBODIMENTS

As described previously, it is known to install a phase adjustment unit that adjusts the phase difference for an instantaneous interruption-free switching of the paths. However, an apparatus will get bigger to achieve the instantaneous interruption-free switching in all paths because the size of the phase adjustment unit will get bigger.

A description will now be given of embodiments of the present invention with reference to the accompanying drawings.

### First Embodiment

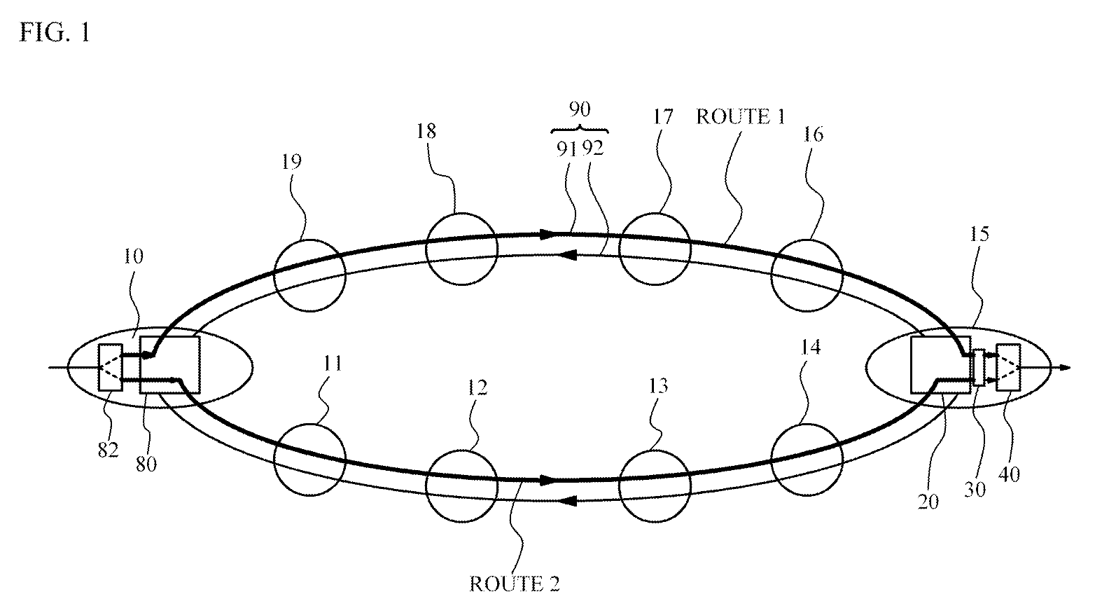

FIG. 1 is a diagram illustrating an overview of a transmission system in accordance with the first embodiment. Referring to FIG. 1, a transmission line 90 such as SDH and SONET is formed into a ring shape. Multiple transmission apparatuses 10 through 19 are coupled via a transmission line 90 in a ring shape. Hereinafter, one of the multiple transmission apparatuses 10 through 19 will be described as a sending apparatus 10, and another one will be described as a receiving apparatus 15. Other transmission apparatuses can behave as a sending apparatus or a receiving apparatus as well. The transmission line 90 includes a first transmission line 91 used to transmit data in one direction (clockwise direction), and a second transmission line 92 used to transmit a signal in another direction opposite to the one direction (counterclockwise direction). Each of the first transmission line 91 and the second transmission line 92 has a capability of transmitting signals of multiple channels. For example, when each of the first transmission line 91 and the second transmission line 92 is a 10 Gbps transmission line, 52 Mbps VC32 can establish 192 channels.

The sending apparatus 10 includes a cross connect unit 80 and a selection unit 82. The selection unit 82 selects a line from the first transmission line 91 and the second transmission line 92 for sending a transmitting signal, with respect to each channel. The cross connect unit 80 can pass and block signals of the first transmission line 91 and the second transmission line 92 with respect to each channel, and output the transmitting signal to the first transmission line 91 and second transmission line 92.

The receiving apparatus 15 includes a cross connect unit 20 (a first cross connect unit), a phase adjustment unit 30 (a first phase adjustment unit), and a selection unit 40 (a first selection unit). The cross connect unit 20 can pass and block signals of the first transmission line 91 and the second transmission line 92 with respect to each channel, and can connect the first transmission line 91 and the second transmission line 92 to the phase adjustment unit 30. The phase adjustment unit 30 can adjust a phase difference between two signals. The selection unit 40 can select a signal with respect to each channel and output the signal as a receiving signal.

In the above transmission system, the path (a route 1), which goes through the sending apparatus 10, the transmission apparatuses 19, 18, 17, 16, and the receiving apparatus 15, and adjusts the phase difference in the receiving apparatus 15 by using the first transmission line 91 as a path to the sending apparatus 10 or the receiving apparatus 15, and the path (a route 2), which goes through the sending apparatus 10, the transmission apparatuses 11, 12, 13, 14, and the receiving apparatus 15 and adjusts the phase difference in the receiving apparatus 15 by using the second transmission line 92, are established. Some of the transmitting signals are transmitted with the route 1 by using some channels of the first transmission line 91. Others are transmitted with the route 2 by using some channels of the second transmission line 92. A time difference of signals occurs because the path of the route 1 is different from the path of the route 2. The phase adjustment unit 30 adjusts the phase difference between the signal of the route 1 and the signal of the route 2. The selection units 82 and 40 select the route 1 or the route 2 with respect to each channel.

TABLE 1

| | |
|---|---|
| ROUTE 1 | 10→19→18→17→16→15(PHASE ADJUSTMENT) |
| ROUTE 2 | 10→11→12→13→14→15(PHASE ADJUSTMENT) |

When failures occur or maintenances are done in the route 2, the path that transmits the channel signal with the route 2 is switched to the path that transmits the channel signal with the route 1. Because of this switching, the signal can be transmitted from the sending apparatus 10 to the receiving apparatus 15 during the failures or the maintenance. Because the phase adjustment unit 30 adjusts the phase difference, an instantaneous interruption-free switching is possible.

The phase adjustment unit 30 with a size of the number of channels of the transmission line 90 is needed to compensate all channels of the transmission line 90 for the instantaneous interruption-free switching. For example, if the size of the transmission line 90 is 10 Gbps (192 channels), the phase adjustment unit 30 with the size of 10 Gbps (192 channels) is needed. However, if the phase adjustment unit 30 of which the size is large is used, the cost reduction and downsizing of the transmission apparatus such as the receiving apparatus 15 are prevented. Meanwhile, if the phase adjustment unit 30 with the size of 5 Gbps (96 channels) is used, the cost reduction and downsizing of the transmission apparatus such as the receiving apparatus 15 may be possible, but the instantaneous interruption-free paths will be 96 channels. Other 96 channels will become normal paths that does not compensate for the instantaneous interruption-free switching.

To solve the problem above, in the first embodiment, the size of the phase adjustment unit 30 in the receiving apparatus 15 is 96 channels, and is less than the number of channels of the transmission line 90. The lack of the size is made up for with the phase adjustment unit in another transmission apparatus (e.g. an intermediate apparatus 14). Hereinafter, the channel signal that adjusts the phase with the phase adjustment unit 30 in the receiving apparatus 15 is described as the first channel signal, and the channel signal that adjusts the phase with the phase adjustment unit in the intermediate apparatus 14 is described as the second channel signal.

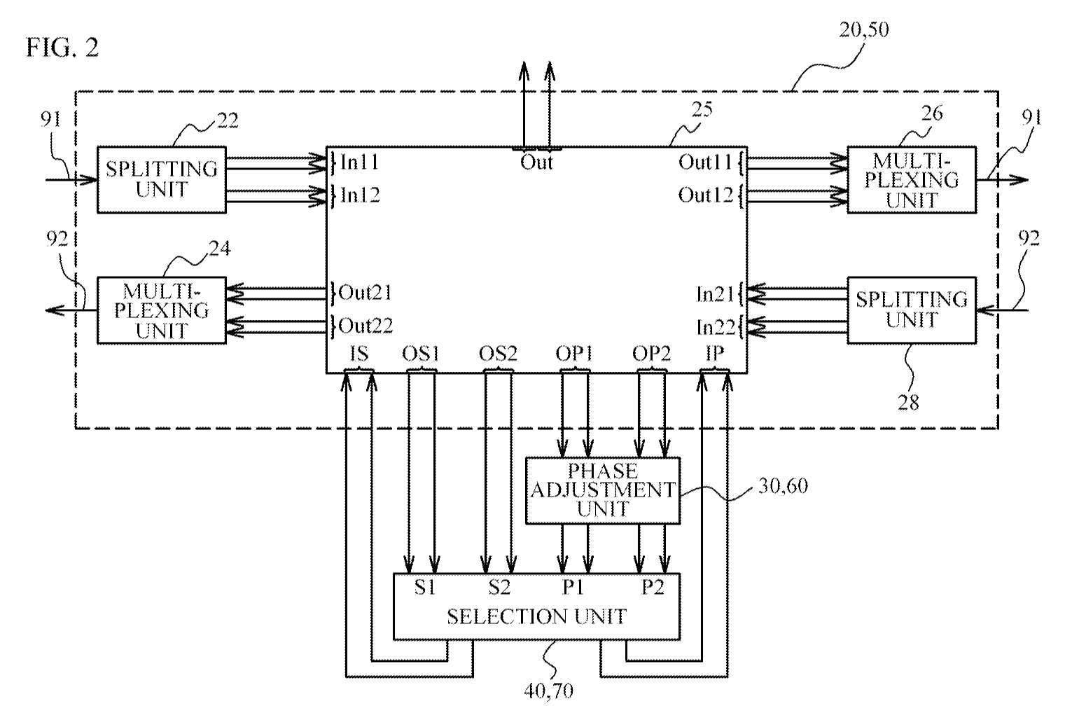

FIG. 2 is a block diagram around the cross connect unit 20. The cross connect unit 20 includes splitting units 22 and 28, multiplexing units 24 and 26, and a connect unit 25. The splitting units 22 and 28 split the signal of the first transmission line 91 and the signal of the second transmission line 92 with respect to each channel, respectively. The connect unit 25 can pass and block the signal of the first transmission line 91 and the signal of the second transmission line 92 with respect to each channel. The connect unit 25 can also connect the signals of the first transmission line 91 and the second transmission line 92 to the phase adjustment unit 30, the selection unit 40, and the output. The multiplexing units 24 and 26 multiplex the signals of multiple channels, and output them to the first transmission line 91 and the second transmission line 92, respectively.

In the connect unit 25, an input of the first channel that is a part of the multiple channels split by the splitting unit 22 is an input In11. An input of the second channel that is another part of the multiple channels is an input In12. In the same way, an input of the first channel split by the splitting unit 28 is an input In21, and an input of the second channel is an input In22. An output of the first channel outputted to the multiplexing unit 26 is an output Out11, an output of the second channel is an output Out12, an output of the first channel outputted to the multiplexing unit 24 is an output 21, and an output of the second channel is an output Out22. Two outputs to the phase adjustment unit 30 are outputs OP1 and OP2 respectively. Inputs corresponding to the outputs OP1 and OP2 from the phase adjustment unit 30 to the selection unit 40 are inputs S1 and S2, respectively. The signal selected from the inputs S1 and S2 is inputted to the input IS of the connect unit 25. An output of the sending apparatus 15 is an output Out.

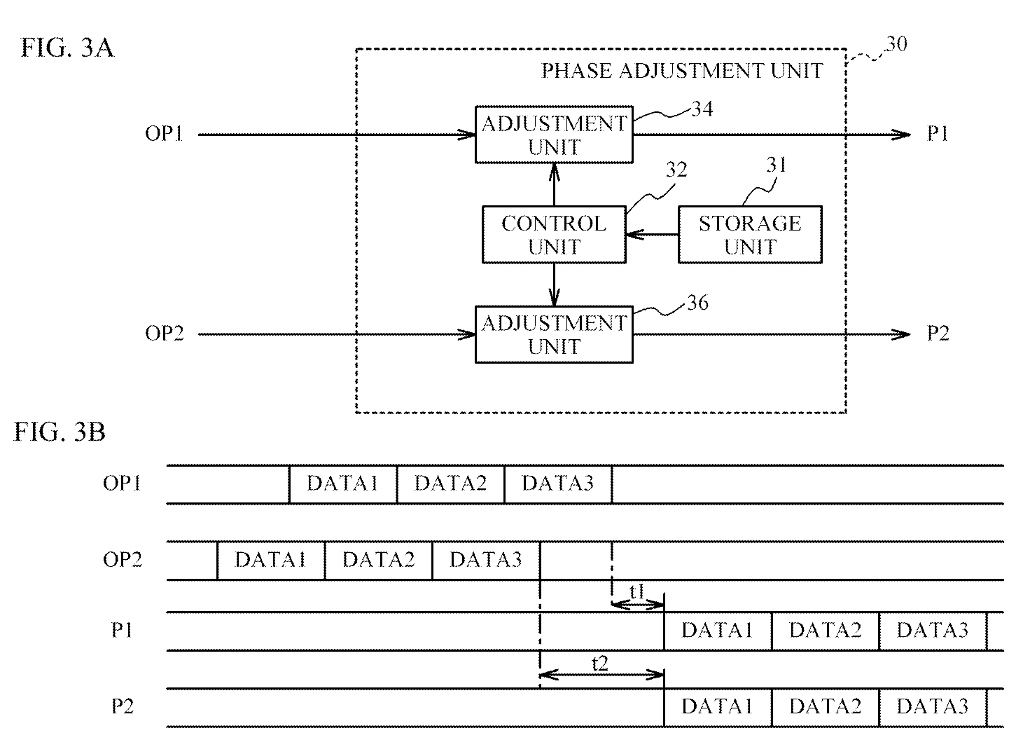

FIG. 3A is a block diagram of the phase adjustment unit 30, and FIG. 3B is a time chart of data that are inputted to the phase adjustment unit 30 and outputted from the phase adjustment unit 30. Referring to FIG. 3A, the phase adjustment unit 30 includes a control unit 32, and adjustment units 34 and 36. The adjustment units 34 and 36 include a storage device such as RAM (Random Access Memory). Signals are inputted to the adjustment units 34 and 36 from the outputs OP1 and OP2 of the cross connect unit 20. The adjustment units 34 and 36 output signals to the inputs P1 and P2 of the selection unit 40. The control unit 32 controls the adjustment units 34 and 36 based on the information, which is stored in the storage unit 31, about the phase difference to be adjusted so that the phase difference between the signals of outputs OP1 and OP2 does not exist.

Referring to FIG. 3B, the time difference (the phase difference) occurs between the signals of the outputs OP1 and OP2 of the cross connect unit 24, and the outputs OP1 and OP2 are corresponding to the first transmission line and the second transmission line respectively. The adjustment units 34 and 36 store the signal data of the outputs OP1 and OP2 respectively, and output the signal data to the inputs P1 and P2 after the predetermined time t1 and t2 that the control unit 32 indicates, respectively. Making the predetermined times that the adjustment units 34 and 36 have different can make the time difference between the signals of the inputs P1 and P2 little. Thus, even though the selection unit 40 switches the input P1 to the input P2, the receiving apparatus 15 can output the signal without the phase difference.

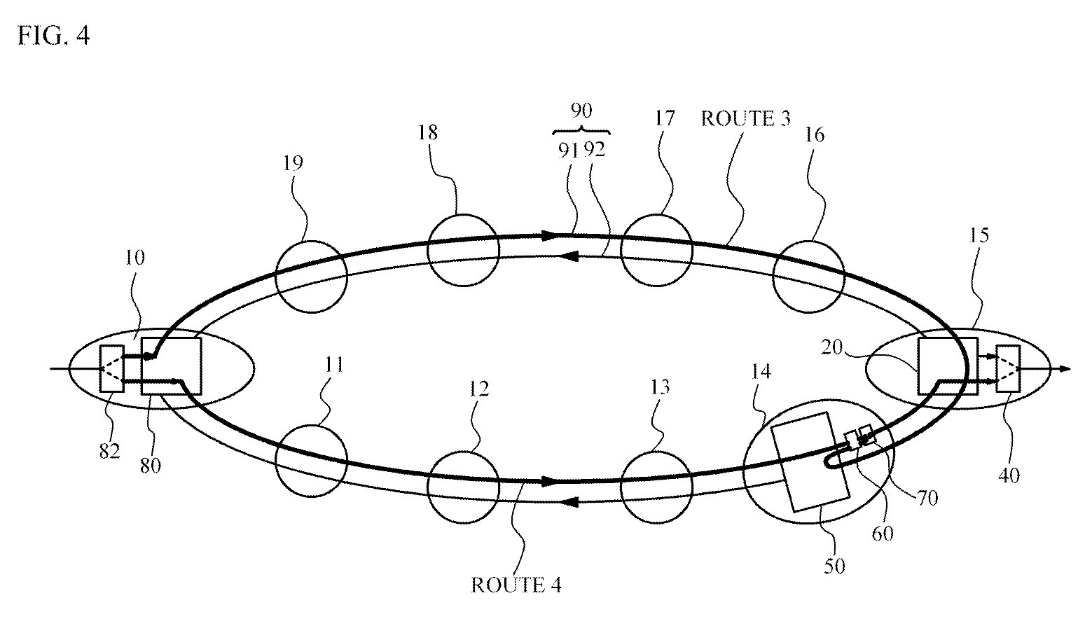

FIG. 4 is a diagram illustrating an overview of the phase adjustment of the second channel, in which the phase adjustment unit 30 in the receiving apparatus 15 can not adjust the phase, with the phase adjustment unit 60 in the intermediate apparatus 14 of the transmission apparatuses. The intermediate apparatus 14 includes a cross connect unit 50 (a second cross connect unit), a phase adjustment unit 60 (a second phase adjustment unit), and a selection unit 70 (a second selection unit). The configurations of the cross connect unit 50, the phase adjustment unit 60 and the selection unit 70 are same as the cross connect unit 20, the phase adjustment unit 30 and the selection unit 40, respectively.

As described in a Table 2, the path (a route 3), which goes through the sending apparatus 10, the transmission apparatuses 19, 18, 17, 16, the receiving apparatus 15, the intermediate apparatus 14, and the receiving apparatus 15, and adjusts the phase in the intermediate apparatus 14 by using the first transmission line 91 as the path of the second channel from the sending apparatus 10 to the receiving apparatus 15, and the path (a route 4), which goes through the sending apparatus 10, the transmission apparatuses 11, 12, 13, the intermediate apparatus 14, and the receiving apparatus 15, and adjusts the phase in the intermediate apparatus 14 by using the second transmission line 92, are established.

TABLE 2

| | |
|---|---|
| ROUTE 3 | 10→19→18→17→16→15→14(PHASE ADJUSTMENT)→15 |
| ROUTE 4 | 10→11→12→13→14(PHASE ADJUSTMENT)→15 |

When the route 1 and the route 2 illustrated in FIG. 1 are established, the phase difference between the route 1 and the route 2 is measured. The storage unit 31 in the phase adjustment unit 30 stores the information about the phase difference. The control unit 32 indicates the time t1 and the time t2 illustrated in FIG. 3B to the adjustment units 34 and 36 based on the phase difference measured. In the same way, when the route 3 and the route 4 illustrated in FIG. 4 are established, the phase difference between the route 3 and the route 4 is measured, and the storage unit 31 in the phase adjustment unit 60 stores the information about the phase difference.

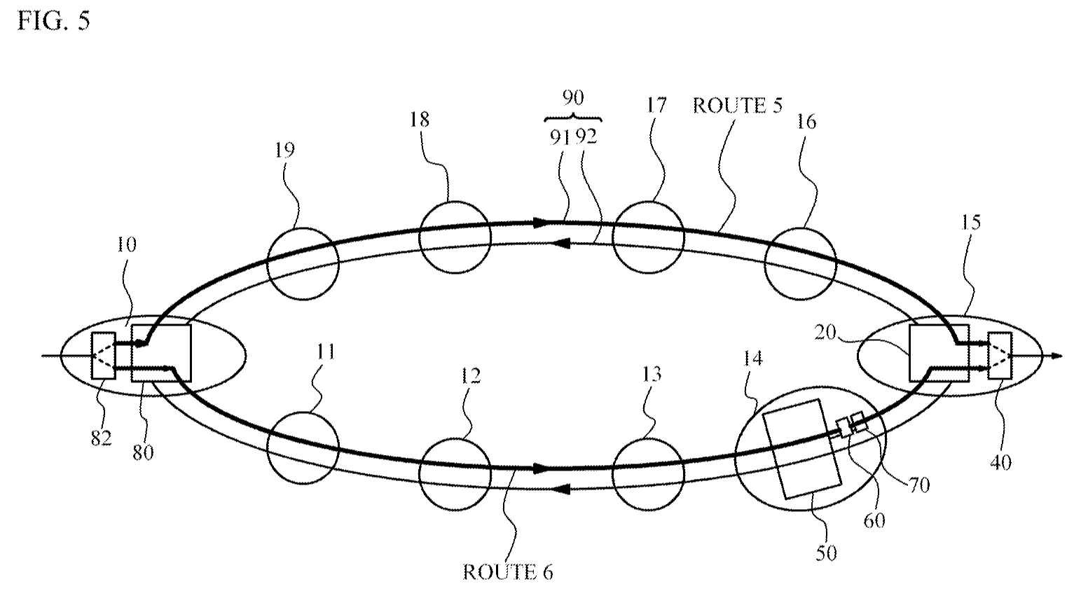

FIG. 5 illustrates the path of the second channel at normal times. As described in Table 3, the path (a route 5), which goes through the sending apparatus 10, the transmission apparatuses 19, 18, 17, 16, and the receiving apparatus 15 by using the first transmission line 91 as the path of the second channel from the sending apparatus 10 to the receiving apparatus 15, and the path (route 6), which goes through the sending apparatus 10, the transmission apparatuses 11, 12, 13, the intermediate apparatus 14, and the receiving apparatus 15 and adjusts the phase in the intermediate apparatus 14 by using the second transmission line 92, are established.

TABLE 3

| | |
|---|---|
| ROUTE 5 | 10→19→18→17→16→15 |
| ROUTE 6 | 10→11→12→13→14→15 |

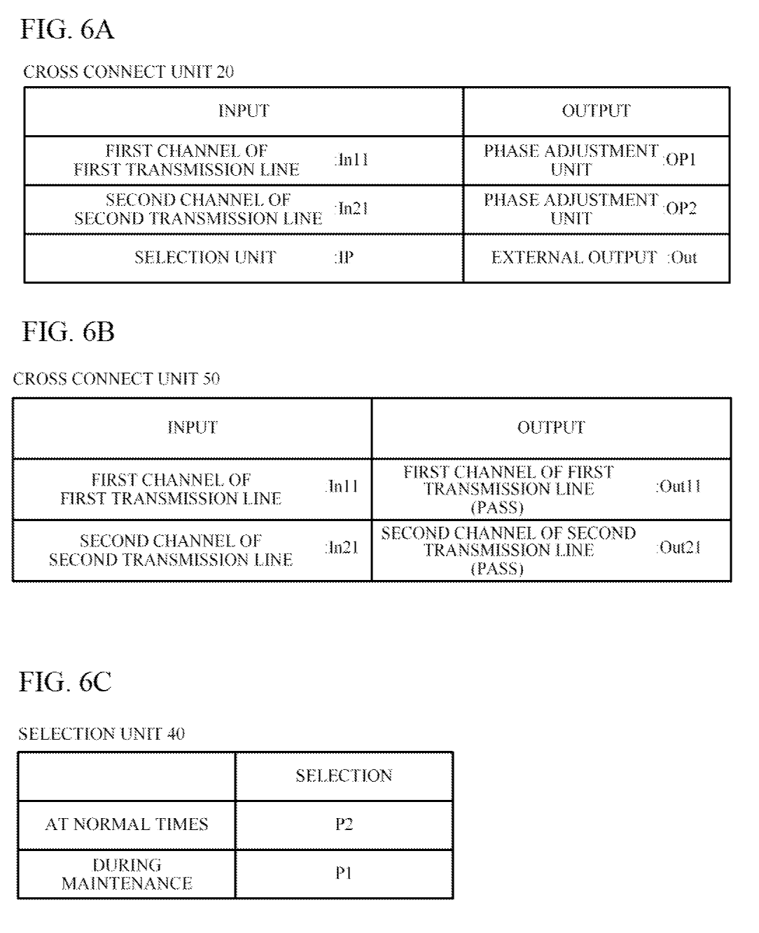

Now the behavior of the transmission system will be described. The first channel will be described first. FIG. 6A is a diagram illustrating a connection relation of the cross connect unit 20 of the first channel, which is corresponding to the inputs In11 and In21, where the receiving apparatus 15 adjusts the phase difference between the route 1 and the route 2 with the route 1 and the route 2. FIG. 6B is a diagram illustrating a connection relation of the cross connect unit 50. FIG. 6C is a diagram illustrating the selection of the selection unit 40.

Referring to FIG. 1 and FIG. 6A, the cross connect unit 20 of the receiving apparatus 15 connects the input In11 and the input In21 to the output OP1 and the output OP2, respectively. Referring to FIG. 6B, the cross connect unit 50 of the intermediate apparatus 14 connects the input In11 and the input In21 to the output Out11 and the output Out21, respectively. Thus, the cross connect units 20 and 50 pass the first channel signals of the first transmission line 91 and the second transmission line 92. Referring to FIG. 6C, the selection unit 40 selects the input P2 at normal times. This means that the path of the first channel signal from the sending apparatus 10 to the receiving apparatus 15 is the route 2. When the transmission apparatuses 11 through 14 or the transmission line 90 are maintained (or failures occur), the selection unit 40 selects the input P1. As illustrated in FIG. 6A, the cross connect unit 20 outputs the input IP from the selection unit 40 to the output Out. Thus, the path of the first channel from the sending apparatus 10 to the receiving apparatus 15 is the route 1. When the path of the first channel signal is switched to the route 1 from the route 2, the instantaneous interruption-free switching of the route is possible, because the phase adjustment unit 30 adjusts the phase difference.

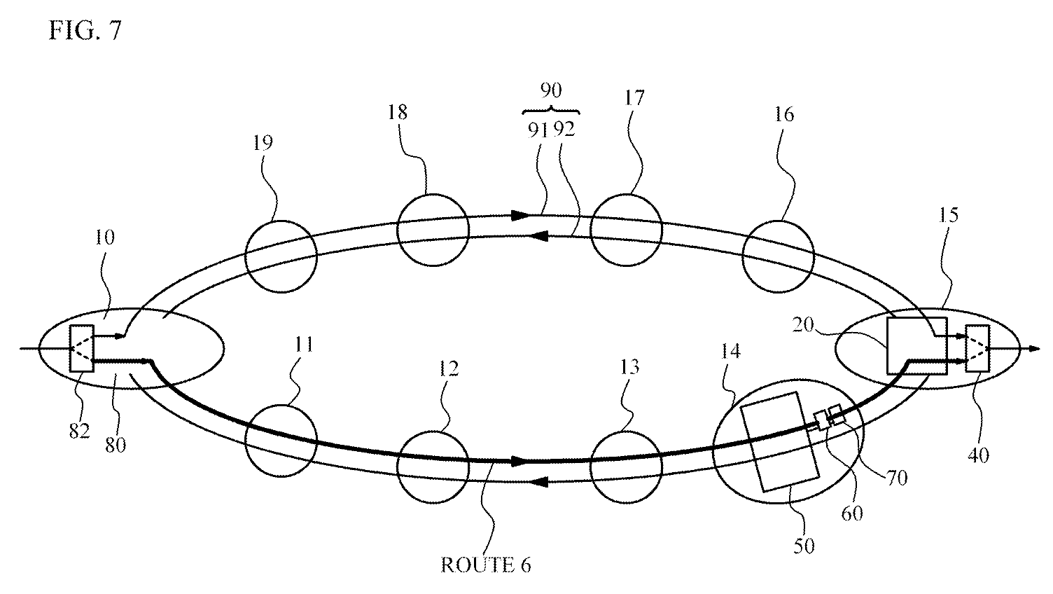

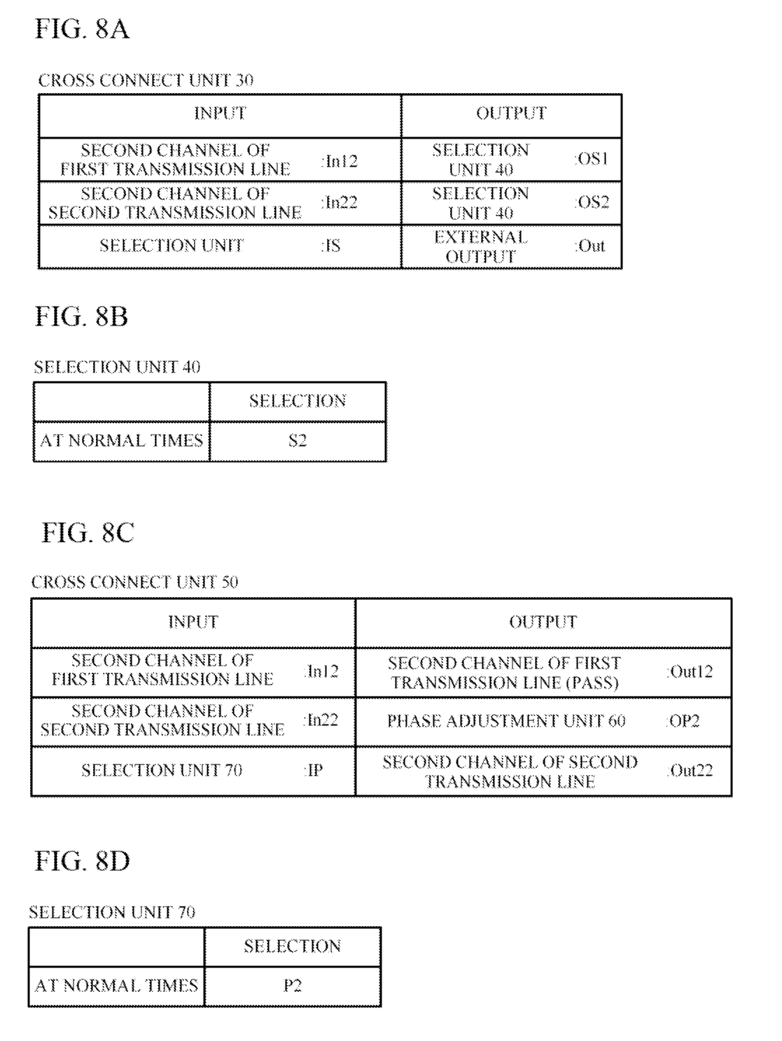

Now the behavior of the second channel at normal times will be described. FIG. 7 is a diagram illustrating an overview of when the path at normal times is the route 6. FIGS. 8A, 8B, 8C, and 8D are illustrating the selection relation of the cross connect unit 20, the selection unit 40, the cross connect unit 50 and the selection unit 70, respectively. Note that FIG. 7 schematically illustrates that the output of the selection unit 70 is not inputted into the cross connect unit 50 for simplification.

As illustrated in FIG. 7 and FIG. 8A, the inputs In12 and In21 of the second channel of the cross connect unit 20 in the receiving apparatus 15 are connected to the output OS1 and the output OS2 respectively. As illustrated in FIG. 8B, the selection unit 40 selects the input S2. As illustrated in FIG. 8A, the input IS from the selection unit 40 is connected to the output Out. Accordingly, the second channel signal of the second transmission line 92 is outputted from the receiving apparatus 15. As illustrated in FIG. 7 and FIG. 8C, the inputs In12 and In22 of the cross connect unit 50 in the intermediate apparatus 14 are connected to the outputs Out12 and OP2 respectively. As illustrated in FIG. 8D, the selection unit 70 selects the input P2. As illustrated in FIG. 8C, the input IP from the selection unit 70 is connected to the output Out22. Accordingly, in the intermediate apparatus 14, the second channel signal of the second transmission line 92 is outputted to the second transmission line 92 via the phase adjustment unit 60.

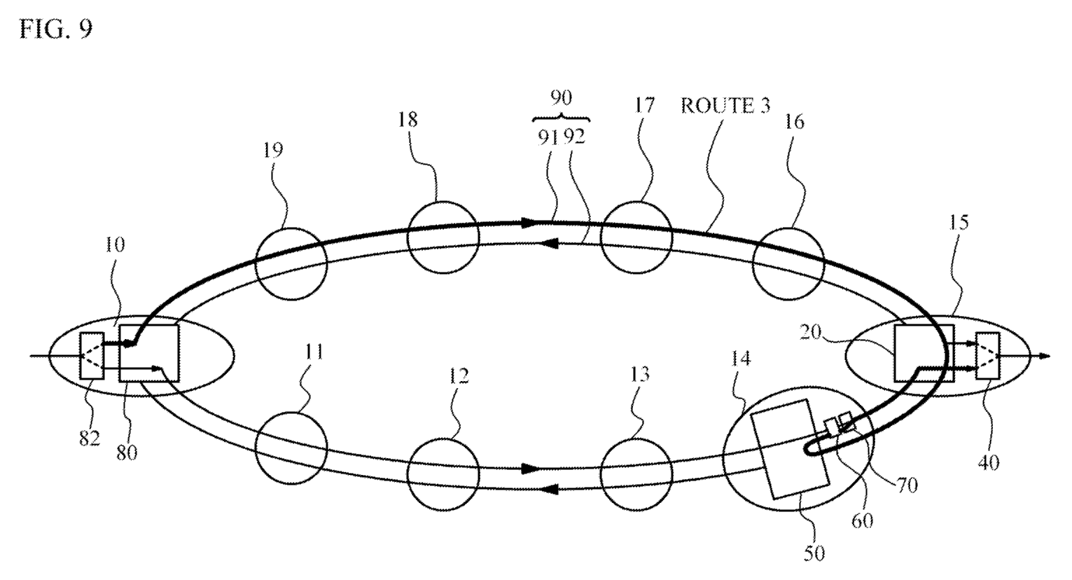

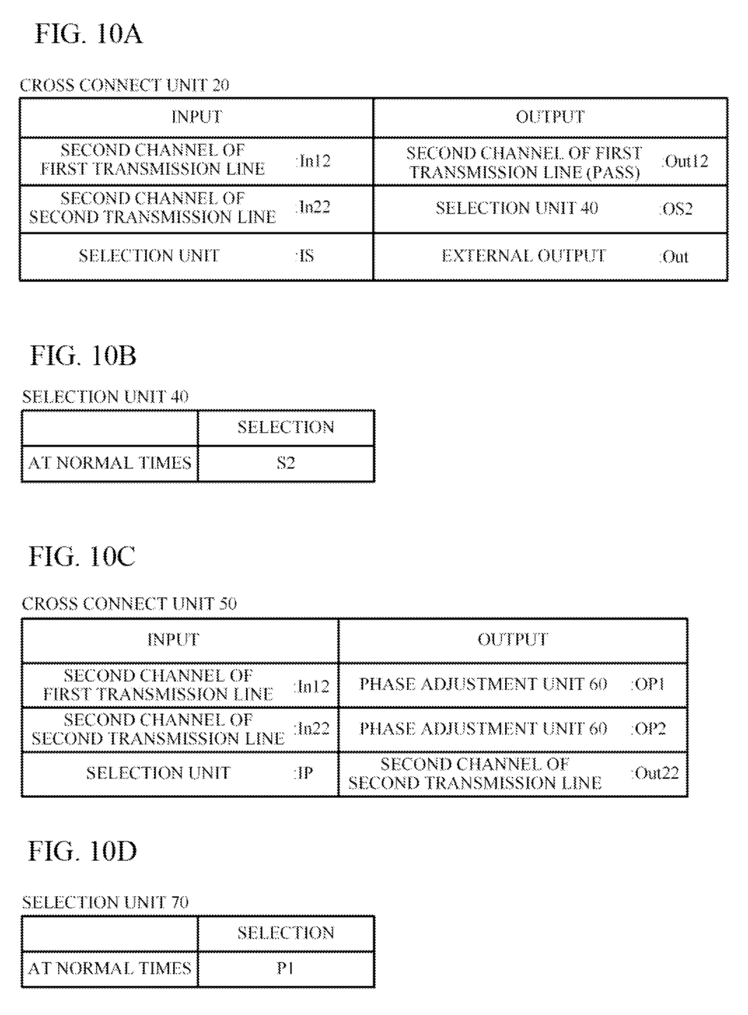

Now the behavior of the second channel during the maintenance will be described. When the maintenance work is needed in the transmission apparatuses 11 through 13 or the transmission line 90 between the sending apparatus 10 and the intermediate apparatus 14, the cross connect units 20 and 50 establish the route 3 and route 4 illustrated in FIG. 4. FIG. 9 is a diagram illustrating the overview of when the path during the maintenance is the route 3. FIGS. 10A, 10B, 10C, and 10D illustrate the selection relation of the cross connect unit 20, the selection unit 40, the cross connect unit 50, and the selection unit 70 respectively.

As illustrated in FIG. 9 and FIG. 10A, the inputs In21 and In22 of the second channel of the cross connect unit 20 in the receiving apparatus 15 are connected to the outputs Out12 and OS2 respectively. Thus, the second channel signal of the first transmission line 91 passes through the cross connect unit 20. As illustrated in FIG. 10B, the selection unit 40 selects the input S2. As illustrated in FIG. 10A, the input IS from the selection unit 40 is connected to the output Out. Accordingly, the second channel signal of the second transmission line 92 is outputted from the receiving apparatus 15. As illustrated in FIG. 9 and FIG. 10C, the inputs In12 and In22 of the cross connect unit 50 in the intermediate apparatus 14 are connected to the outputs OP1 and OP2 respectively. As illustrated in FIG. 10D, the selection unit 70 selects the input P1. As illustrated in FIG. 10C, the input IP from the selection unit 70 is connected to the output Out22. Accordingly, in the intermediate apparatus 14 the second channel signal of the first transmission line 91 is outputted to the second transmission line 92 via the phase adjustment unit 60.

As described above, the route 6 is used as the path of the second channel from the sending apparatus 10 to the receiving apparatus 15 at normal times. During the maintenance the route 6 is switched to the route 3. When the path of the second channel signal is switched to the route 3 from the route 6, the instantaneous interruption-free switching of the route is possible because the phase adjustment unit 60 adjusts the phase difference.

According to the first embodiment, as described in FIG. 1 and FIG. 9, in the receiving apparatus 15, the phase adjustment unit 30 adjusts the phase difference between the first channel signal of the first transmission line 91 and the first channel signal of the second transmission line 92. In the intermediate apparatus 14, the phase adjustment unit 60 adjusts the phase difference between the second channel signal of the first transmission line 91 and the second channel signal of the second transmission line 92. As described above, by dividing the phase adjustment between the receiving apparatus 15 and the intermediate apparatus 14, the size reduction of the phase adjustment unit 30 in the receiving apparatus 15, and the downsizing and cost reduction of the receiving apparatus 15 are possible.

Additionally, as illustrated in FIG. 6A and FIG. 6C, the selection unit 40 in the receiving apparatus 15 selects one of the first channel signal of the first transmission line 91 adjusted and the first channel signal of the second transmission line 92 adjusted, and outputs it. As illustrated in FIGS. 10A and 10B, the cross connect unit 20 outputs the second channel signal of the first transmission line 91, and passes the second channel signal of the second transmission line 92. As illustrated in FIG. 6B, the cross connect unit 50 of the intermediate apparatus 14 passes the first channel signal of the first transmission line 91 and the first channel signal of the second transmission line 92. As illustrated in FIGS. 10C and 10D, the selection unit 70 selects one of the second channel signal of the first transmission line 91 adjusted and the second channel signal of the second transmission line 92 adjusted, and outputs it to the first transmission line 91. Accordingly, the phase difference adjustment of the first channel is executed in the phase adjustment unit 30 of the receiving apparatus 15, and the phase difference adjustment in the second channel is executed of the phase adjustment unit 60 of the intermediate apparatus 14.

According to the configurations described above, even though the number of channels, which can adjust the phase differences, of each of the phase adjustment unit 30 and the phase adjustment unit 60, is less than the sum of channels of the first channel and the second channel, the path using the first channel and the second channel can be the instantaneous interruption-free path.

Furthermore, the transmission apparatus that is the receiving apparatus 15 can behave as the intermediate apparatus. When the transmission apparatus behaves as the receiving apparatus, as described in FIG. 6A and FIG. 6C, the selection unit 40 selects one of the first channel signal of the first transmission line 91 adjusted and the first channel signal of the second transmission line 92 adjusted, and outputs the selected signal to the external. Meanwhile, when the transmission apparatus behaves as the intermediate apparatus, as illustrated in FIGS. 8A, 8D, 10C and 10D, the selection unit 70 selects one of the second channel signal of the first transmission line 91 adjusted and the second channel signal of the second transmission line 92 adjusted, and sends the selected signal to the second transmission line 92. As described above, the selection units 40 and 70 can output the selected signal to both the second transmission line 92 and the external.

When the transmission apparatus behaves as the receiving apparatus, the cross connect unit 20 outputs the second channel signal of the second transmission line 92 to the external, and passes the second channel signal of the first transmission line 91 as illustrated in FIGS. 10A and 10B. Meanwhile, when the transmission apparatus behaves as the intermediate apparatus, as illustrated in FIG. 6B, the cross connect unit 50 passes each of the first channel signal of the first transmission line 91 and the first channel signal of the second transmission line 92. As described above, the cross connect units 20 and 50 can execute all operations mentioned above.

### Second Embodiment

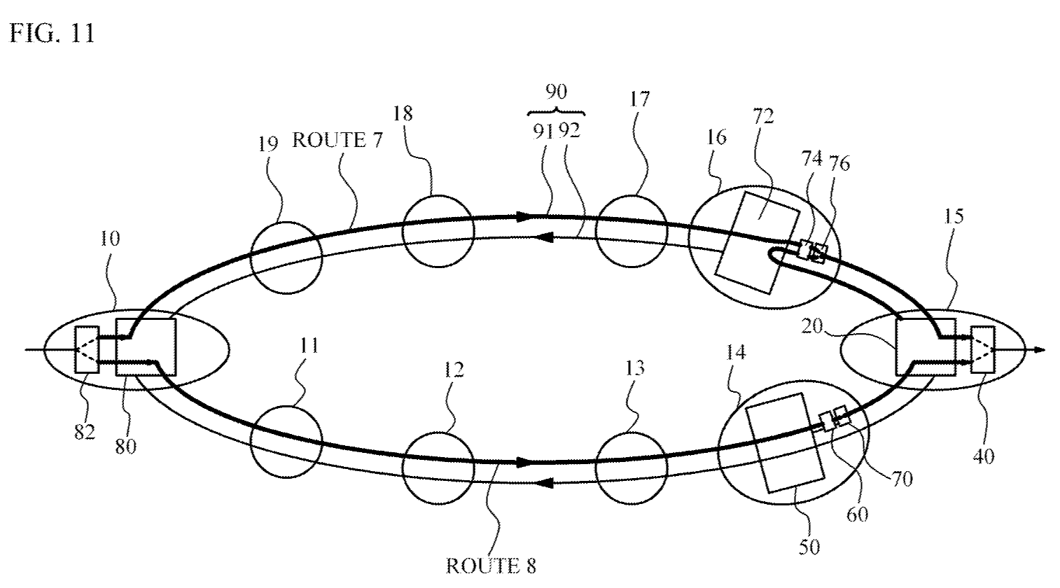

The second embodiment is an example that the transmission apparatus 18 is another intermediate apparatus. As described in FIG. 11, the transmission apparatus 18 includes the cross connect unit 72, the phase adjustment unit 74, and the selection unit 76. The cross connect unit 72, the phase adjustment unit 74, and the selection unit 76 behave same as the cross connect unit 50, the phase adjustment unit 60, and the selection unit 70 in the first embodiment. In this configuration, the path (a route 7), which goes through the sending apparatus 10, the transmission apparatuses 19, 18, 17, 18 and the receiving apparatus, and adjusts the phase in another intermediate apparatus 16, and the path (a route 8), which goes through the sending apparatus 10, the transmission apparatuses 11, 12, 13, 14, the receiving apparatus 15, another intermediate apparatus 16, and the receiving apparatus 15, and adjusts the phase in another intermediate apparatus 16, are established. Accordingly, the instantaneous interruption-free switching of the path is possible even when the maintenance is done in the transmission apparatuses 17 through 19, the sending apparatus 10 or the transmission line 90 between the transmission apparatuses 19 and 16.

The configurations of all transmission apparatuses can be same as the configuration of the intermediate apparatus 14. Thus, the phase adjustment can be done by using the phase adjustment unit of the transmission apparatus that is other than the transmission apparatus next to the receiving apparatus 15. Additionally, the phase adjustment can be done in more than three phase adjustment units. As described above, multiple intermediate apparatuses can be installed.

### Third Embodiment

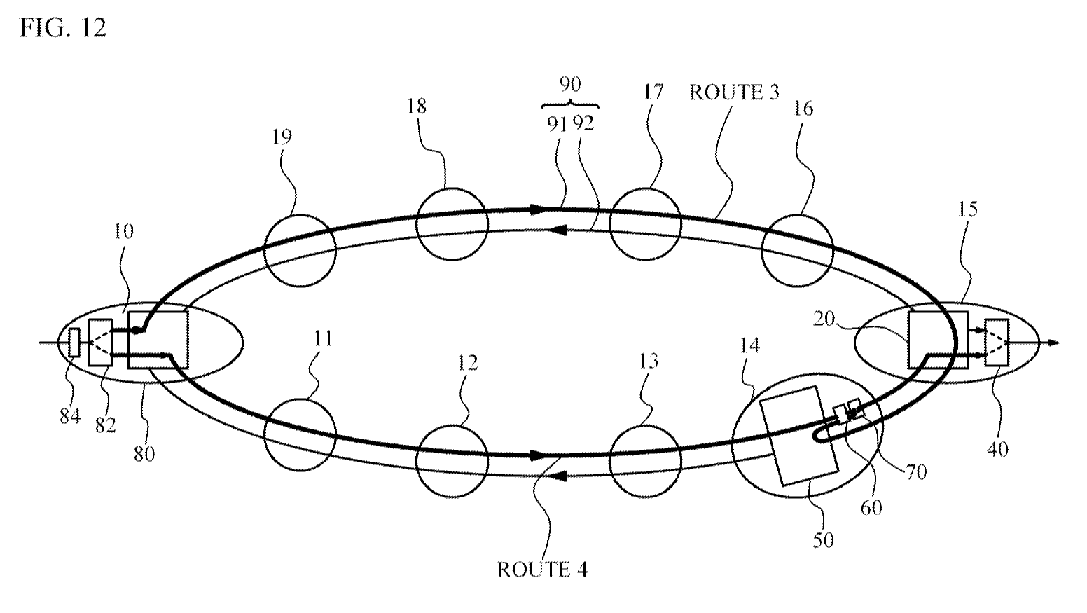

The third embodiment is an example that the phase adjustment unit adjusts the phase difference based on the signal transmitted from the sending apparatus. FIG. 12 is a block diagram in accordance with the third embodiment. As described in FIG. 12, the sending apparatus 10 includes a J1 insert unit 84. The J1 insert unit 84 inserts the J1 multi-frame into the overhead as a signal for adjusting the phase difference between the first transmission line 91 and the second transmission line 92. Other configurations are same as the configurations illustrated in FIG. 4.

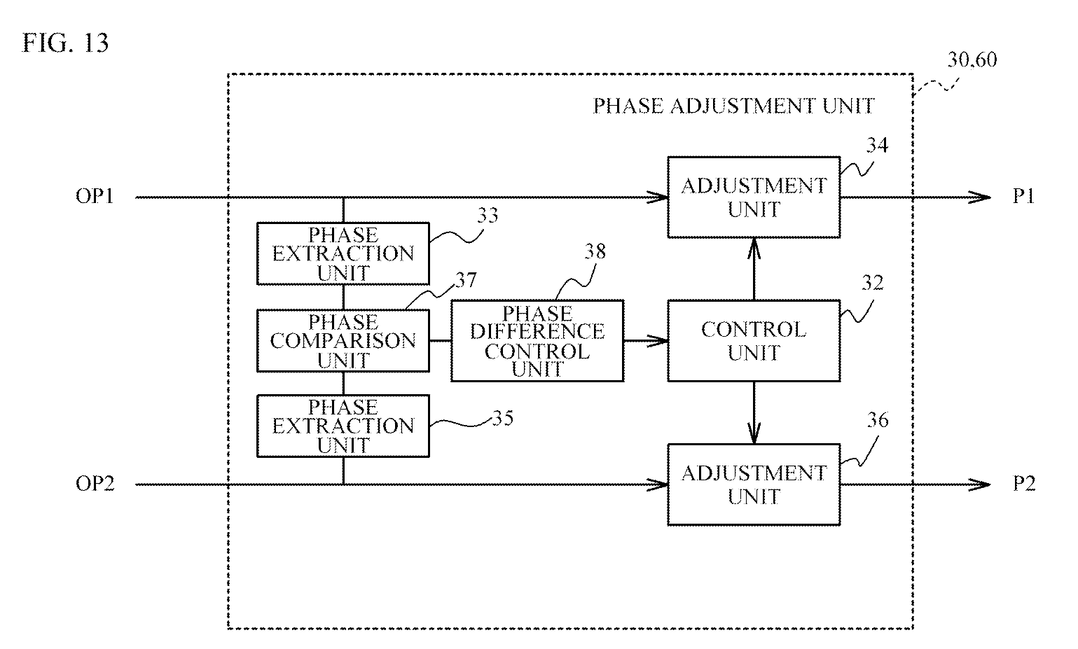

FIG. 13 is the block diagram of the phase adjustment units 30 and 60. As described in FIG. 13, the phase adjustment unit 30 includes phase extraction units 33 and 35, a phase comparison unit 37, and a phase difference control unit 38. The phase extraction units 33 and 35 extract the J1 multi-frame from the signals of the first transmission unit 91 and the second transmission unit 92 respectively. The phase comparison unit 37 compares the phases extracted by the phase extraction units 33 and 35. The phase difference control unit 38 determines the time that the adjustment units 34 and 36 delay the phase based on the comparison result of the phase comparison unit 37. The control unit 32 controls the phase difference between the signal of the first transmission line 91 and the signal of the second transmission line 92, as described in FIG. 3B.

According to the third embodiment, the sending apparatus 10 transmits the signal to adjust the phase difference between the first transmission line 91 and the second transmission line 92, and the phase adjustment unit 30 and the phase adjustment unit 60 can adjust the phase difference based on the signal mentioned above. Note that the method disclosed in the Japanese Patent Laid Open. 2005-244806 can be used for the method of the phase adjustment with the J1 multi-frame.

### Fourth Embodiment

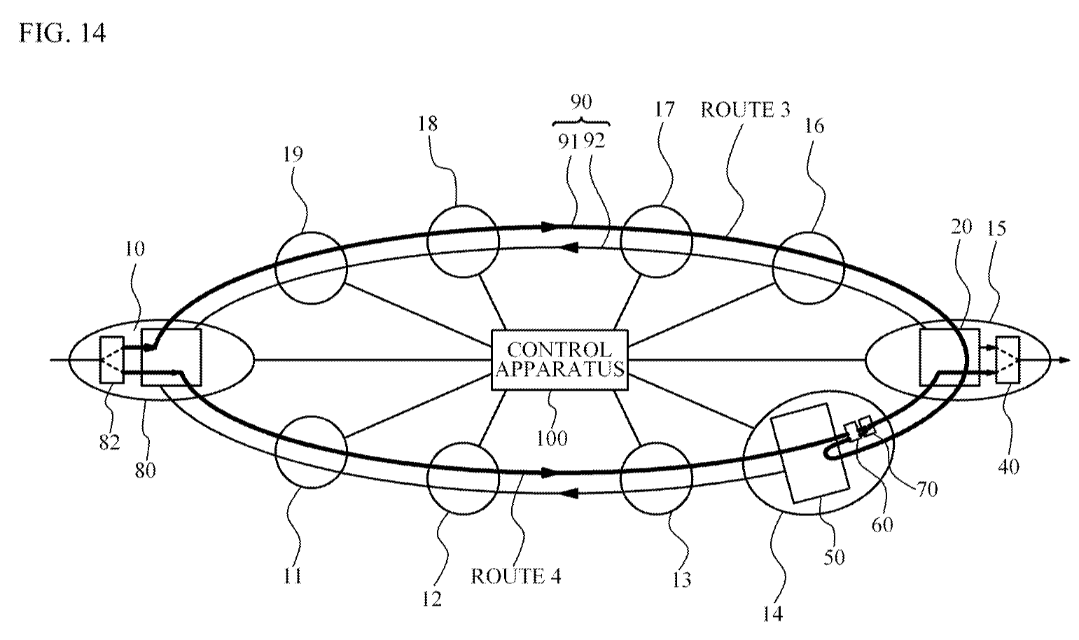

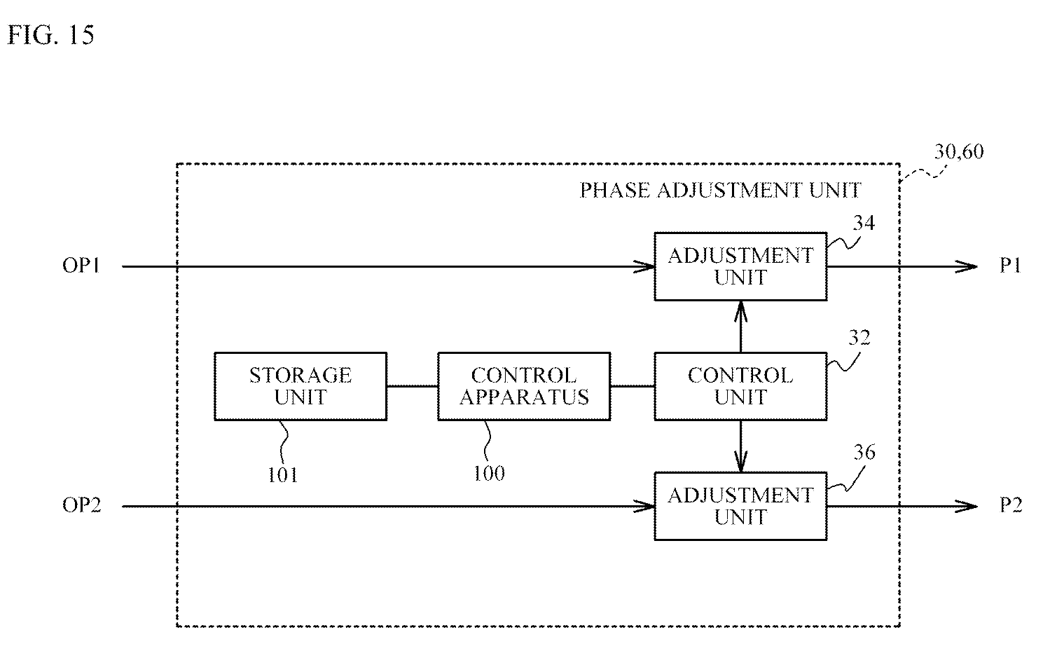

FIG. 14 is a block diagram in accordance with the fourth embodiment. As described in FIG. 14, a control apparatus 100 controls the sending apparatus 10, the receiving apparatus 15, the intermediate apparatus 14, and the transmission apparatuses 11 through 13 and 16 through 19. FIG. 15 is a block diagram of the phase adjustment units 30 and 60. The control unit 32 is controlled by the control apparatus 100. When the route 1 and the route 2 in FIG. 1 are established and when the route 3 and the route 4 in FIG. 4 are established, the phase difference between the route 1 and the route 2 and the phase difference between the route 3 and the route 4 are stored in a storage unit 101. When the phase adjustment units 30 and 60 adjust the phase, the control apparatus 100 indicates the information about the phase difference stored in the storage unit 101 to the control unit 32. The control unit 32 controls the adjustment units 34 and 36 based on the information about the phase difference indicated.

Note that as described in the fourth embodiment the control apparatus 100 that controls the transmission system can store the information about the phase difference into the storage unit 101.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various change, substitutions, and alterations could be made hereto without departing from the spirit and scope of the invention.

What is claimed is:

1. A transmission system comprising:
a sending apparatus;
a receiving apparatus; and
an intermediate apparatus,
the sending apparatus, the receiving apparatus and the intermediate apparatus being connected in a ring shape via a first transmission line used to transmit a first channel signal and a second channel signal in one direction and a second transmission line used to transmit the first channel signal and the second channel signal in another direction opposite to the one direction,
the receiving apparatus including a first phase adjustment unit that adjusts a phase difference between the first channel signal of the first transmission line and the first channel signal of the second transmission line, and
the intermediate apparatus including a second phase adjustment unit that adjusts a phase difference between the second channel signal of the first transmission line and the second channel signal of the second transmission line.

2. The transmission system according to claim 1, wherein the receiving apparatus comprises:
a first selection unit that selects one of the first channel signal of the first transmission line adjusted and the first channel signal of the second transmission line adjusted, and outputs a selected signal; and
a first cross connect unit that outputs the second channel signal of the first transmission line, and passes the second channel signal of the second transmission line,
and wherein the intermediate apparatus comprises:
a second selection unit that selects one of the second channel signal of the first transmission line adjusted and the second channel signal of the second transmission line adjusted, and outputs a selected signal to the first transmission line; and
a second cross connect unit that passes each of the first channel signal of the first transmission line and the first channel signal of the second transmission line.

3. The transmission system according to claim 1, wherein the number of channels in which the phase difference is adjustable by each of the first phase adjustment unit and the second phase adjustment unit is less than a sum of channels of the first channel and the second channel.

4. The transmission system according to claim 1, wherein a plurality of the intermediate apparatuses are installed.

5. The transmission system according to claim 1, wherein the sending apparatus sends a signal to adjust a phase difference between the first transmission line and the second transmission line, and the first phase adjustment unit and the second phase adjustment unit adjust the phase difference based on the signal.

6. A transmission apparatus for a transmission system in which a plurality of transmission apparatuses are connected in a ring shape via a first transmission line used to transmit a first channel signal and a second channel signal in one direction, and a second transmission line used to transmit the first channel signal and the second channel signal in another direction opposite to the one direction, said transmission apparatus comprising:
a phase adjustment unit that adjusts one of a phase difference between the first channel signal of the first transmission line and the first channel signal of the second transmission line, and a phase difference between the second channel signal of the first transmission line and the second channel signal of the second transmission line;
a selection unit that can both selects one of the signal of the first channel of the first transmission line adjusted and the first channel signal of the second transmission line adjusted and outputs a selected signal to external, and selects one of the second channel signal of the first transmission line adjusted and the second channel signal of the second transmission line adjusted and outputs a selected signal to the second transmission line; and
a cross connect unit that can both outputs the second channel signal of the second transmission line to external and passes the second channel signal of the first transmission line, and passes each of the first channel signal of the first transmission line and the first channel signal of the second transmission line.

7. A method for controlling a transmission system in which a sending apparatus, a receiving apparatus, and an intermediate apparatus are connected in a ring shape via a first transmission line used to transmit a first channel signal and a second channel signal in one direction and a second transmission line used to transmit the first channel signal and the second channel signal in another direction opposite to the one direction, said control method comprising:
adjusting a phase difference between the first channel signal of the first transmission line and the first channel signal of the second transmission line in the receiving apparatus;
adjusting a phase difference between the second channel signal of the first transmission and the second channel signal of the second transmission line in the intermediate apparatus.

8. The method according to claim 7, further comprising:
outputting the signal of the second channel of the first transmission line in the receiving apparatus;
passing the second channel signal of the second transmission line;
selecting the second channel signal of the first transmission line adjusted or the second channel signal of the second transmission line adjusted in the intermediate apparatus;
outputting a selected signal to the first transmission line in the intermediate apparatus; and
passing each of the first channel signal of the first transmission line and the first channel signal of the second transmission line in the intermediate apparatus.
